(19) United States
(12) Patent Application Publication
(10) Pub. No.: US 2007/0039990 A1
(43) Pub. Date: Feb. 22, 2007

(54) Impact induced crack propagation in a brittle material

(76) Inventors: Marvin William Kemmerer, Montour Falls, NY (US); Yawei Sun, Horseheads, NY (US); Ljerka Ukrainczyk, Painted Post, NY (US); Wei Xu, Painted Post, NY (US); Naiyue Zhou, Painted Post, NY (US)

Correspondence Address: CORNING INCORPORATED, SP-TI-3-1, CORNING, NY, 14831, US

(21) Appl. No.: 11/588,051

(22) Filed: Oct. 26, 2006

Related U.S. Application Data
(63) Continuation-in-part of application No. 11/124,435, filed on May 6, 2005.

(51) Int. Cl. B26F 3/00

(52) U.S. Cl. 225/2; 225/94; 83/880

(57) ABSTRACT

A sheet of brittle material, such as glass, flat or bowed, is separated along a score line by applying vibration energy through a probe into previously scored sheet material. The separation time is less than 1 second with smooth edge quality. The brittle material can be in the form of a moving ribbon of glass sheet, where a vibrational load is applied transverse to the score line to enhance crack propagation along the score line. A controller operates the probe at selected vibration frequencies, amplitudes, contact velocities, contact forces of impact, alignment with the score line, and the like, depending on material properties and structure, and depending on optimal process parameters.

This is a continuation-in-part application of co-assigned application Ser. No. 11/124,435, filed May 6, 2005, entitled ULTRASONIC INDUCED CRACK PROPAGATION IN A BRITTLE MATERIAL, the entire contents of which are incorporated herein in their entirety.

### BACKGROUND OF THE INVENTION

1. Field of the Invention

The present application relates to the separation of a sheet of brittle material, and more particularly, to crack initiation and propagation along a score line in response to the application of mechanical energy applied to the brittle material.

2. Description of Related Art

Two techniques are conventionally employed for cutting or shaping a sheet of brittle material, such as a glass, amorphous glass, glass-ceramic or ceramic material, to form a piece with a desired configuration or geometry.

A first conventional method involves mechanical scribing of the sheet by a hard device such as a diamond or tungsten tip to score the surface of the brittle material, which is then broken along the score line in response to a significant bending moment applied to the material. Typically, the bending moment is applied by physically bending the brittle material about the score line. However, the amount of bending movement and amount of movement of the sheet must be carefully controlled since bending can result in multiple break origins along the score line and can even result in crack out (i.e., cracks extending away from the score line). Further, significant bending in a direction perpendicular to the sheet can also create disturbances to the sheet shape (which may have a slight bowed shape), with the bending process causing flattening of the sheet during the bending and then releasing the sheet after separation, which potentially contributes significantly to sheet stress. Under worst case, bending separation will not work if the degree of sheet bow is too high. In addition, bending separation could provide an opportunity for edge rubbing to take place, which generates chips along the edges.

The second conventional technique involves laser scribing, such as described in U.S. Pat. No. 5,776,220. Typical laser scribing includes heating a localized zone of the brittle material with a continuous wave laser, and then immediately quenching the heated zone by applying the coolant, such as a gas, or a liquid such as water. The separation of laser scribed material can be achieved either by mechanical breaking using bending as with the mechanical scribing, or by a second higher energy laser beam. The use of the second higher energy laser beam allows for separation without bending. However, the separation is slow and often it is difficult to control crack propagation. The second laser beam also creates thermal checks and introduces high residual stress.

Therefore, the need exists for the fast, repeatable and uniform separation that allows minimized bending of a sheet of brittle material, and that minimizes manipulation of the sheet. The need also exists for a minimized disturbance separation that can be used during vertical forming process (on the draw) or during horizontal forming (e.g. float glass). The need also exists for reducing the twist-hackle distortion commonly associated with aggressive bend induced separation, and improve separation edge quality. The need exists for the consistent separation of a brittle material along a score line, without requiring physical bending of the material, or the introduction of extreme temperature gradients. There is a particular need for the separation of a pane from a continuously moving ribbon of brittle material within very short period of time (less than 1 second), while reducing imparted disturbances which can propagate upstream along the ribbon.

### SUMMARY OF THE INVENTION

The present invention provides for the fast separation of a brittle material without requiring application of a bending moment, through impact loading without generating significant shear motion. The present system also provides for the fast, repeatable and uniform separation of a pane of brittle material from a continuously moving ribbon of the brittle material, while reducing the introduction of disturbances into the ribbon. The present system further allows for a separation of a sheet of brittle material which reduces twist-hackle commonly observed in aggressive bending moment induced separation, and therefore improve edge quality and reduce glass particle caused by separation.

The present system can be used for separating a stationary, independent or fixed sheet of material. However, particular applicability has been found for separating a pane from a ribbon of material, and further applicability has been found for separating a pane of glass from a moving ribbon of glass. It has also been found that the present system works effectively with hot glass above 300° C.

Generally, impact energy from a vibrating tip is applied to the brittle material to initiate a crack and propagate the crack along a previously formed score line. Typically, the impact energy is applied in the local region of the score line on a side of the material opposite the score line so that the stresses generated by the impact energy cause tension in the material at the score line for optimal crack initiation and propagation, but with minimal movement of the sheet material in a direction perpendicular to the sheet.

In a further configuration, separation of the brittle material along the score line is enhanced by application of a transverse load to the score line prior to application of the impact energy. By applying a load, the sheet is tensioned and sheet lateral stiffness increased, which increases the stress concentration at the bottom of the score line and facilitates the crack growth. High sheet lateral stiffness also helps the crack propagation along the score line. By selecting the amplitude of the impact energy, contact force, contact speed and the tension across the score line, the present system can be used to separate a number of brittle materials at different rates. Vibration frequency of the impact energy will affect the separation speed when it is too low.

In a current configuration for separating a pane of glass from a continuous ribbon of the glass, the present invention controls and/or reduces the introduction of detrimental disturbances that can migrate upstream in the ribbon and adversely affect ribbon forming process. The present invention can also separate the glass at a high speed (e.g.: less than 1 second), which is sometimes critical for the dynamic application of the manufacturing process. The present can separate more than 2 m wide at less than 1 second at proper settings.

Additional features and advantages of the invention are set forth in the detailed description which follows, and in part will be readily apparent to those skilled in the art from that description or recognized by practicing the invention as described herein. For purposes of description, the following discussion is set forth in terms of glass manufacturing. However, it is understood the invention as defined and set forth in the appended claims is not so limited, except for those claims which specify the brittle material is glass.

It is to be understood that both the foregoing general description and the following detailed description are merely exemplary of the invention, and are intended to provide an overview or framework for understanding the nature and character of the invention as claimed below. Also, the above listed aspects of the invention, as well as the preferred and other embodiments of the invention discussed and claimed below, can be used separately or in any and all combinations.

The accompanying drawings are included to provide a further understanding of the invention, and are incorporated in and constitute a part of this specification. The drawings illustrate various embodiments of the invention, and together with the description serve to explain the principles and operation of the invention. It should be noted that the various features illustrated in the figures are not necessarily drawn to scale. In fact, the dimensions may be arbitrarily increased or decreased for clarity of discussion.

### DESCRIPTION OF THE DRAWINGS

FIG. 1 is a perspective schematic view showing an apparatus for forming a ribbon of brittle material.

FIG. 2 is a front elevational schematic view of the ribbon extending from a fusion glass fabrication apparatus.

FIG. 3 is a side elevational schematic view of vibration impact energy applied to the ribbon.

FIG. 4 is a side elevational view of a horizontal sheet of brittle material for separation by the application of vibration impact energy with appropriate support.

FIG. 5 is a side elevational view of a sheet of brittle material for separation by the application of vibration impact energy in conjunction with an applied load transverse to the score line.

FIG. 6 is an enlarged side elevational schematic view similar to FIG. 3, but showing stress levels and directions within the glass sheet.

FIG. 7 is a front elevational view of a batch-type process having a hanging sheet and a vibrating probe for separating the sheet along a score line in a manner similar to that shown in FIGS. 3 and 6.

FIGS. 8-12 are graphs showing the result of down force (or tensile load along the sheet) on separation (FIG. 8, down force versus separation time), the result of probe and score line alignment on separation (FIG. 9, alignment offset versus separation time), the result of probe contact speed on separation (FIG. 10, probe traveling velocity versus separation time), the result of probe contact force on sheet separation (FIG. 11, probe contact force versus separation time), and the result of probe travel on sheet separation (FIG. 12, probe frequency versus probe travel to sheet separation).

### DETAILED DESCRIPTION OF EMBODIMENTS

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention can be practiced in other embodiments that depart from the specific details disclosed herein. Moreover, descriptions of well-known devices, methods and materials may be omitted so as not to obscure the description of the present invention.

The present invention provides for the impact induced separation of a brittle material without requiring a bending of the brittle material. The present invention further avoids using a single high force blow to cause crack propagation. The present invention provides way to control separation time and edge quality. In one configuration, the present invention provides for the separation of a pane of a brittle material from a moving ribbon of the material, wherein selected configurations reduce the introduction of disturbances which can propagate upstream in the ribbon. For purposes of description, the present invention is initially set forth as separating a glass pane from a moving ribbon of glass.

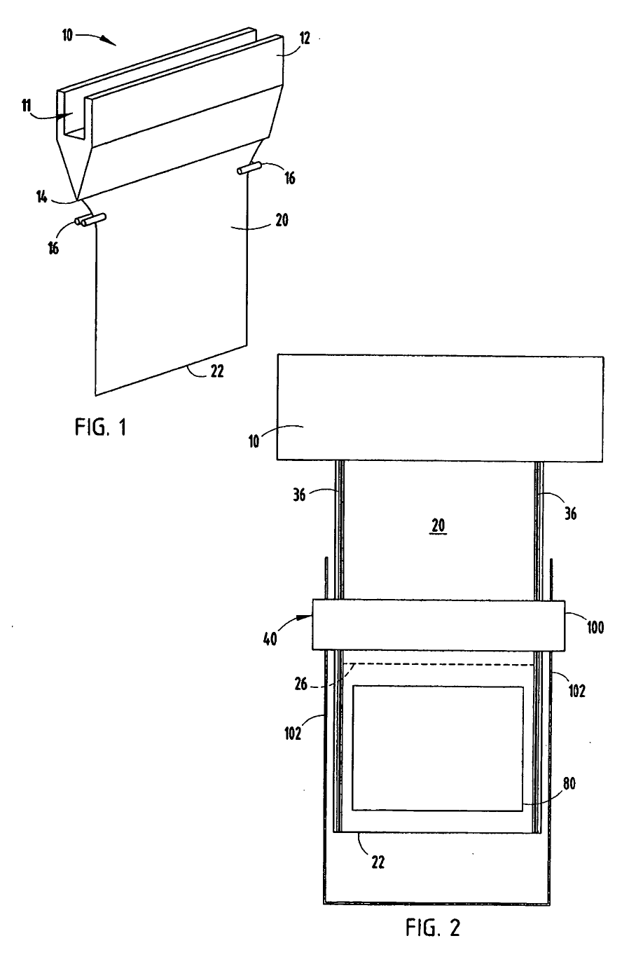

FIG. 1 is a schematic diagram of glass fabrication apparatus 10 of the type typically used in the fusion process. The apparatus 10 includes a forming isopipe 12, which receives molten glass (not shown) in a cavity 11. The molten glass flows over the upper edges of the cavity 11 and descends along the outer sides of the isopipe 12 to a root 14 to form the ribbon of glass 20. The ribbon of glass 20, after leaving the root 14, traverses fixed edge rollers 16. The ribbon 20 of brittle material is thus formed and has a length extending from the root 14 to a terminal free end 22.

Such draw down sheet or fusion processes, are described in U.S. Pat. No. 3,338,696 (Dockerty) and U.S. Pat. No. 3,682,609 (Dockerty), and herein incorporated by reference. Thus, details are omitted so as to not obscure the description of the example embodiments. It is noted, however, that other types of glass fabrication apparatus can be used in conjunction with the invention. For those skilled in the art of glass forming, it is known that there are multiple methods to achieve such a structure, such as laminated down draw, slot draw and laminated fusion processes.

In the fusion, or other type of glass manufacturing apparatus, as the glass ribbon 20 travels down from the isopipe 12, the ribbon changes from a supple, for example 50 millimeter thick liquid form at the root 14, to a stiff glass ribbon of approximately 0.03 mm to 2.0 mm thickness, for example, at the terminal end 22.

In the formation process of the ribbon 20, the ribbon transforms from a liquid state at the root 14 to a down the stream solid state at the terminal end 22 of the ribbon. The introduction of disturbances into the transforming glass can result in undesired nonuniformity in the resulting glass in the solid state. Traditionally, the separation of a pane from the ribbon, introduced significant energy in the form of a wave or distortion to the solid portion of the ribbon. Such distortion would migrate upstream into the transition from the molten portion of the ribbon to the solid portion. As the distortion dissipates in the transformation portion of the ribbon, nonuniformity and nonlinearity are introduced in an uncontrolled manner, and can decrease the uniformity of subsequent panes. In addition, ribbon motion in the forming region results in high stress after the ribbon cools down, which affects ribbon stability.

For purposes of definition, as the ribbon 20 descends from the root 14, the ribbon travels at a velocity vector describing movement of the ribbon and forms a generally flat member having a generally planar first side 32 (often referred to as the A side) and a generally planar second side 34 (often referred to as the B side). In certain configurations, as seen in FIG. 2, the ribbon 20 includes lateral beads or bulbous portions 36 which are sized for engagement by the fixed rollers 16 or control surfaces during travel of the ribbon from the isopipe 12. With respect to the ribbon 20, the terms “opposed” or “opposing” mean the contact on both the first side and the second side of the ribbon.

The term “upstream” means from the point of interest on the ribbon 20 to the root 14. The term “downstream” means from the point of interest to the terminal end 22 of the ribbon 20.

The separation of a pane 24 from the ribbon 20 occurs within a given distance range from the root 14, along a score line 26 formed in at least one side of the ribbon. That is, under constant operating parameters, the glass ribbon 20 reaches a generally predetermined solid state at a generally constant distance from the root 14, and is thus amenable to separation.

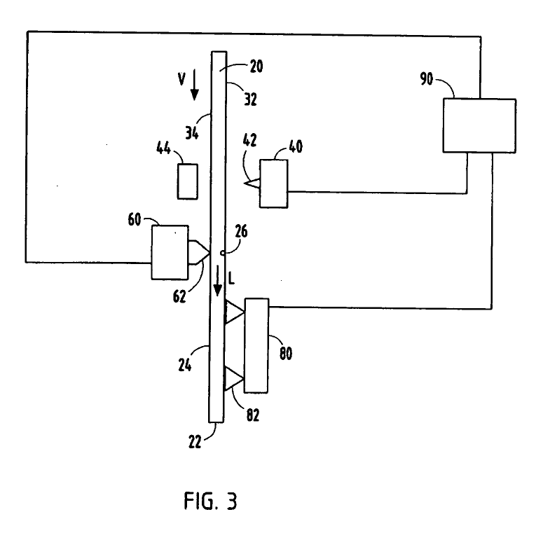

As illustrated in FIG. 3, the present system includes a scribing assembly 40, a vibration (e.g.: ultrasonic) applicator 60 and a loading assembly 80.

The scribing assembly 40 is used to form a score line 26 on the first side 32 of the ribbon 20. The scribing assembly 40 includes a scribe 42 and in certain configurations, a scoring anvil 44. For purposes of description, the scribe 42 and the scoring anvil 44 are described in terms of travel on a common carriage 100 shown in FIG. 2, and omitted from FIG. 3 for clarity. The carriage 100 can be movable relative to a frame 102, wherein the movement of the carriage can be imparted by any of a variety of mechanisms including mechanical or electromechanical, such as motors, gears, rack and pinion, to match the velocity vector of the ribbon 20.

Thus, the scribe 42 will travel along the direction of travel of the ribbon 20, at a velocity vector matching the ribbon. As the scribe 42 translates along the same direction of travel as the ribbon 20, the score line 26 can be formed to extend transverse to the direction of travel of the ribbon.

The scribe 42 can be any of a variety of configurations well known in the art, including but not limited to lasers, wheels, points or tips, including diamond, carbide, zirconium or tungsten.

For those configurations of the scribe 42 that require contact with the ribbon 20 to form the score line 26, the scribe is also movable between a retracted non-contacting position and an extended ribbon contacting position.

For contacting scribes, the scribe 42 cooperates with the scoring anvil 44 to form the score line 26 along the first surface 32 of the ribbon 20.

Typically, the score line has a depth of approximately 10% of the thickness of the sheet material, the ribbon 20. Thus, for the ribbon 20 having a thickness of approximately 0.7 mm to 1.3 mm, score line 26 can have a depth ranging from approximately 70 microns to 130 microns. For glass panes used in display systems, or substrates, the ribbon usually has a thickness between 0.4 mm and 3.0 mm, thus the score line 26 can have a depth ranging from approximately 40 microns to 300 microns. However, it is understood that different materials, operating temperatures and ultrasonic applicators 60 can require an adjustment of the depth of the score line 26 with respect to the thickness of the ribbon 20.

In the separation of the pane 24 from the ribbon 20, the score line 26 is linear and extends across the ribbon between the beads 36. Thus, score line 26 has a longitudinal dimension extending along a length of the score line.

The vibration applicator 60 applies mechanical impact energy to the ribbon 20. The vibration applicator converts high frequency electrical energy e.g., 20 kHz) to a longitudinal vibration at the applicator/probe tip. A variety of mechanisms can be used to generate the high frequency impact. For example, an ultrasonic vibration probe, an oscillator crystal or a magnetostrictive modulator, such as a nickel rod in a strong magnetic alternating field can be used. The vibration applicator 60 includes a coupler slender probe 62 for introducing the vibration energy to the ribbon 20. The probe 62 can have any of a variety of configurations such as a line, point, sphere, flat surface. The profile of the probe tip affects the separation efficiency, which will be discussed later. The vibration amplitude of the tip plays a key role in separation process.

In the embodiment of FIGS. 1-5, the impact energy typically is in the form of a mechanical vibration. The frequency of the vibration is between approximately 10 Hz and approximately 400 kHz. However, it is understood that frequencies greater than 400 kHz, such as approximately 700 kHz to approximately 1.2 MHz can be employed. An advantage of using high frequencies at ultrasonic range (greater than 15 kHz) is to gain high separation efficiency-quick separation. Both vibration frequency and amplitude affect separation efficiency. Mechanically, high vibration frequency system generally yields low vibration amplitude due to the material constraint and configuration of the vibration probe 62. When using an ultrasonic vibration probe, the amplitude of the vibration amplitude is typically in range from approximately 20 micrometers to approximately 200 micrometers, with a satisfactory range of approximately above 100 micrometers for quick separation.

The loading assembly 80 shown in FIGS. 2 and 3 is employed to apply a load or force L on the ribbon 20 transverse to the longitudinal dimension of the score line. That is, the loading is along the direction of travel of the ribbon 20 to apply the tension to the sheet. In the configuration for separating a pane 24 from the ribbon 20, the loading is along the velocity vector V.

In one configuration, the loading assembly 80 also engages the ribbon 20 downstream of the score line 26 and controls removal of the pane 24 upon separation from the ribbon 20. A representative loading and pane engaging assembly 80 and associated transporter are described in U.S. Pat. No. 6,616,025, herein expressly incorporated by reference.

The loading assembly 80 includes pane engaging members 82, such as soft vacuum suction cups. It is understood other devices for engaging the pane 24, such as clamps can be used. The number of pane engaging members 82 can be varied in response to the size, thickness and weight of the pane 24.

The loading assembly 80 can employ any of a variety of mechanisms for applying the loading across the score line 26. For example, pneumatic or hydraulic pistons or cylinders can be connected to the pane engaging members to apply a force parallel to or coextensive with the velocity vector of the ribbon 20. Preferably, the loading assembly 80 can apply a controllable and adjustable transverse force across the score line 26. Typical loading values can range from approximately 2 pounds to 50 pounds, depending upon the length of the score line 26 and the material being separated. Generally, it is advantageous to apply a sufficient tension, such as by the loading assembly, to enhance efficiency of crack propagation as long as it does not cause problem up stream. For example, a loading of at least a about 0.2 lb/in (or about 10 pounds for 1300 mm wide sheet) will work acceptably.

It is understood the loading assembly 80 can engage the ribbon 20 either before or after the score line 26 is formed.

A controller 90 can be operably connected, by hard wire or wireless, to at least one of the scribing assembly 40, the vibration applicator 60 and the loading assembly 80 to coordinate operation of the components. The controller 90 can be a processor embedded in one of the components. Alternatively, the controller 90 can be a dedicated processor or a computer programmed to allow cooperative control of the scribing assembly 40, the vibration applicator 60 and the loading assembly 80 to provide for separation of the pane 24 from the ribbon 20. That is, the controller 90 can allow for sequencing of the formation of the score line 26, application of the tension transverse to the score line and application of the vibration energy.

In operation, the scribing assembly 40 forms the score line 26 across the first side 32 of the ribbon 30. Subsequently, the vibration probe 62 is brought into proximity, or contact with the second side 34 of the ribbon 20 and imparts the impact energy, typically in the form of a mechanical vibration to the ribbon 20. By contacting the ribbon 20, the probe 62 provides a relatively high efficiency of energy transfer to the ribbon. The coupler should contact the region at opposite side of score line to initiate separation. The separation must be fast enough (less than 1 second) to meet the dynamic process needs. The alignment of the probe tip to the score line is important for quick separation. For immediate separation, the tip of the probe must be aligned well with the score line. The exact position at which the probe 62 is contacted with the ribbon 20 depends in part on the geometry of tip. So large size tip requires less accuracy for tip positioning. However, with the increase of tip size, the separation efficiency reduces. For fast separation, about ø⅛ inch tip is recommended and score line and tip surface area must overlap, for example.

The vibration impact energy initiates a crack at the contact point along the score line 26 and assists subsequent crack propagation along the score line. Depending upon the vibration amplitude of the probe, the depth of the score line 26, the amount of tension applied transverse to the score line and the composition of the ribbon 20, the crack propagation can extend along the entire length of the score line. In selected configurations, the crack can propagate beyond the length of the score line 26 to achieve full sheet separation.

It is further contemplated that a single or a plurality of probes 62 can be simultaneously, or sequentially contacted with the ribbon 20 to induce crack propagation along a local section of the score line 26. Although practically, it is difficult to synchronize them. As a result, a simple probe is preferred for initiating the crack. It is believed advantageous to apply sufficient loading along the sheet in conjunction with optimal probe speed, contact force to provide for crack propagation along the entire length of the score line from a single initiation point. In addition, it is advantageous that the vibration energy is continuously applied during the crack propagation. Depending on the location of the loading device contacting the sheet, the sheet lateral stiffness along the score line is different. It is advantageous to apply probe tip at the highest lateral stiffness region to achieve quick separation.

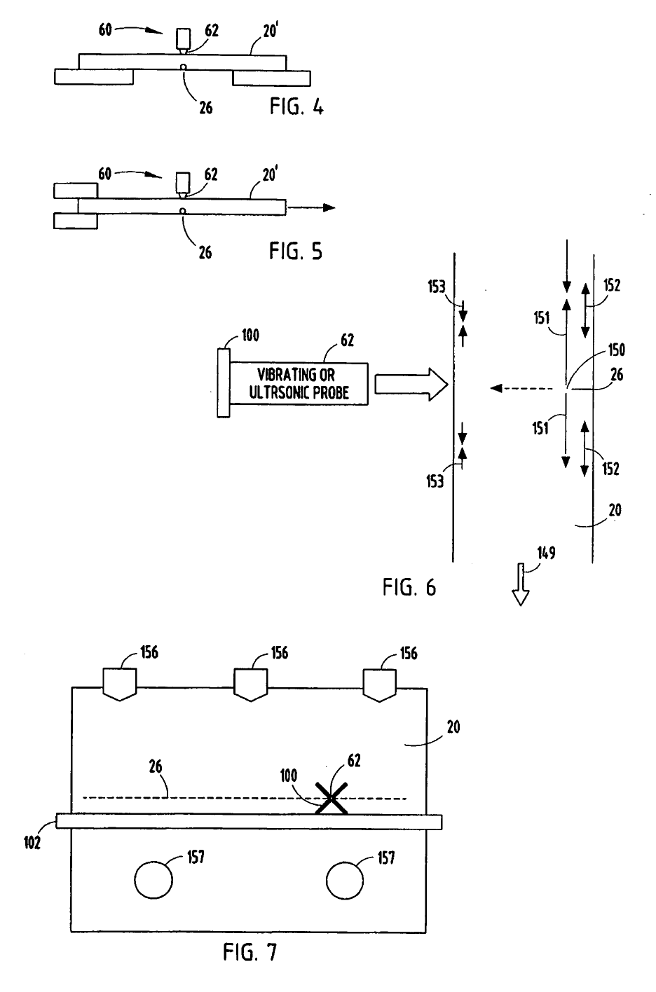

Referring to FIG. 4, a scored sheet 20′ of glass is disposed on a horizontal surface with a gap under the score line. The vibration probe introduces impact energy to the unscored side of the sheet 20′. In FIG. 5, the sheet 20′ is clamped with respect to the substrate by clamp 18 and a tensile load L is applied transverse to the length of the score line 26.

In theory it is believed that vibration applicator 60 transfers low amplitude vibration to the ribbon 20 from the back side of the score line as shown in FIG. 6. It will generate tensile stress at the bottom of the score and cause the crack to grow through the thickness of the sheet. The vibration transferred to the sheet from the probe helps with the crack propagation along the score line. If the ribbon 20 is tensioned, it helps both the crack initiation and propagation processes.

With reference to specific examples, to further illustrate the invention, without limiting the invention, is a first example, a score line 26 having a 70 micron depth was formed in a glass sheet having thickness of 0.7 mm. Thus, the score line had a depth of 10% of the substrate thickness. The sheet was supported, with the score side of the sheet facing the horizontal surface as seen in FIG. 4. An ultrasonic vibration probe 60, with an about ø⅛ inch probe tip operating at 20 kHz was placed in contact with the sheet right opposite the score line 26. Full separation was achieved. If sheet was tensioned as shown in FIG. 5, the separation was faster/more efficient. The separation process is insensitive to the score line depth as long as it exceeds 5% of the thickness.

In a second example, the score line 26 was formed in a rectangular glass sheet of approximately 1.3 meters by 1.1 meter, with a thickness of 0.7 mm. The score line had a depth of 70 micrometers (10% of the sheet thickness) and extended across the width of the sheet. The scored sheet was vertically oriented with the score line 26 extending horizontally, and a 6 pound load was attached to the sheet below the score line. The same ultrasonic vibration probe 60, as used in the first example, operating at 20 kHz, was used with the probe tip 62 contacting the unscored side of the sheet right opposite the score line. A crack initiated and propagated along the entire length of the score line 26 from a single initiation point, with no observable twist-hackle.

The present inventors have discovered that sheet separation can be attained by a probe operating at vibration frequencies starting from 50 Hz as long as vibration energy, frequency, and sheet movement in a perpendicular direction to the sheet is closely controlled. It is reasonable to conclude that vibration frequency less than 50 Hz can also be used to separate glass sheet.

FIG. 6 is similar to FIG. 3, but enlarged to show stress within the glass sheet 20. Thus, FIG. 6 is intended to illustrate a continuous process, as shown in FIG. 1. The illustrated probe 62 can be motivated by any one of several different means. For example, the motivator can be selected from an ultrasonic device, a piezoelectric vibration device, an electric motor driven device, and a pneumatically operated device. The probe 62 is supported for movement across the glass 20 on a side opposite the score line but in alignment with the score line, such as for movement along tracks on a carriage 100 that moves with the glass sheet during the separation process. Devices for movably supporting the probe are known and need not be described in detail for an understanding of the present invention. Also, controllers for controlling operation of vibrational device, movement of the probe (toward the glass sheet as well as along the glass sheet), and other mechanisms are sufficiently known in the art for the purpose of the present disclosure.

The glass 20 (FIG. 6) includes a score line 26 having a depth (of about 10% of glass thickness) and forming a crack tip/front 150. A down force 149 on the ribbon of glass 20 increases the sheet lateral stiffness which based on the mathematical modeling, significantly increases the stress level at the crack tip for a given probe impact as illustrated by high stress lines 151 at the crack tip/front 150. The stress generated at 150 is tensile stress, which helps to open up the crack through the thickness of the sheet 20. The effect of the impact on a laterally stuffed sheet is equivalent to the bending separation of the sheet with minimal sheet lateral motion. In addition, mathematical modeling verifies that in order to generate high tensile stress at the crack tip, vibration probe must be aligned well with the score line. Impact vibration also helps crack propagation along the score line for a full sheet separation.

FIG. 7 illustrates how this same stress arrangement can be implemented in a batch-type process using a hanging sheet held with clamps 156 along a top edge and tensioned with bottom holders 157 (e.g., vacuum cups), and using a vibrating probe 62 (previously called a “coupler” herein) in a manner similar to that shown in FIGS. 3 and 6.

As further discussed below, the tip of probe 62 must vibrate at a frequency sufficient to cause a dynamic stress intensity factor exceeding the critical internal stress intensity factor of the glass material, thus causing a crack to propagate from the score line through the glass thickness. Specifically, as the probe 62 engages the surface on the second side 34 of the glass sheet, a localized dynamic load is applied to the contacted surface. During the impact, the velocity of the motion is initially “v” as the probe tip impacts the glass material, and then is zero at the instant of maximum deflection of the glass sheet. The work done by the horizontal (perpendicular) motion of the impact subjected into the glass is balanced by the resisting work done by the glass. The applied force from the probe tip results in a static bending stress in the glass sheet in a vicinity of the score line crack, and the dynamic load results in a dynamic bending stress. The bending stress in the neighborhood of the impact area is tensile at the score line first side surface 32, and is compressive at the impacted second side surface 34. The local bending stress leads to concentrated tensile stress at the crack tip/front 150. The crack propagates and mode I fracture occurs when the dynamic bending stress is greater than a critical value of the material, which results in a dynamic stress intensity factor exceeding the critical stress intensity factor, as noted above. Notably, the stress intensity factor is generally a function of the material structure and crack geometries, the applied bending stress, and the crack size. Process factors may also limit allowable amplitude and frequency of the probe, such as sensitivity of the upstream sheet to vibrations from downstream sources, special constraints around the process, and the like.

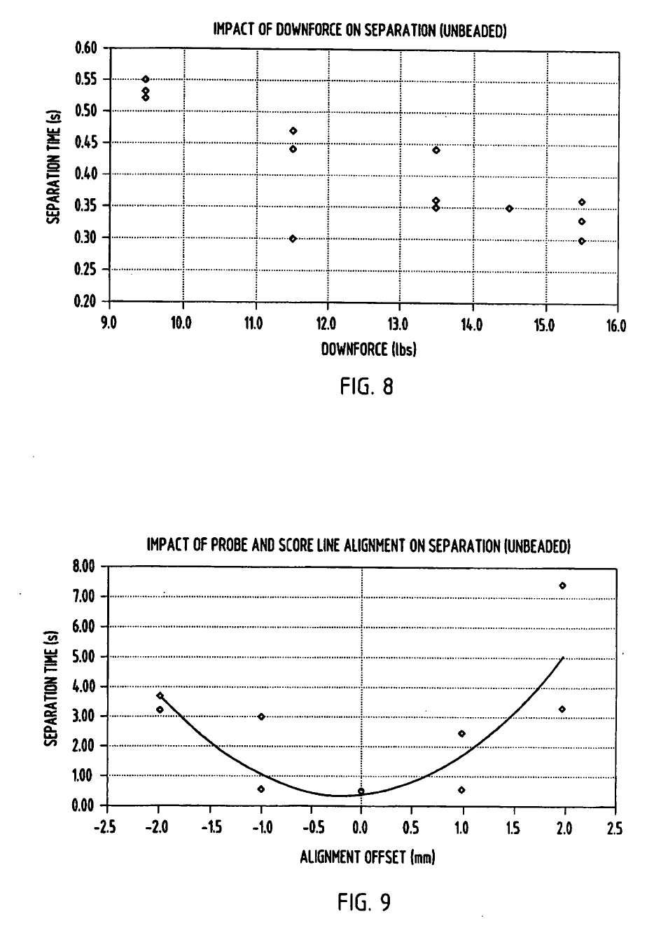

FIG. 8 shows the impact of down force (i.e., in-plane longitudinal tension on the sheet) on separation. The separation time decreases with an increase of down force. However, it is noted that a higher downward force increases the lateral stiffness of the glass sheet and reduces the static deflection, and hence increases the impact factor. The data of FIG. 8 was taken using a forward pressure of 255 g, ultrasonic vibrational settings of 20%, probe speed of 10 mm/s and a probe location spaced inboard of a side edge of the glass (such as about 6 inches inboard) for glass having a thickness of less than about 1 mm and a total width of at least 1 mm. The data illustrates that separation times of about 0.5 seconds (with a down force of about 8-12 pounds and preferably 9.5 pounds) can be reduced to about 0.35 seconds (with down force of 15.0 pounds). Thus, a 2 meter wide sheet can be separated in less than two seconds, and more preferably in less than one second.

Alignment of the probe with the score line is important, as shown in FIG. 9. The distance from the impact contact point to the crack (i.e., the score line) is determined by a cross-sectional dimension of the probe tip, and by alignment of the probe with the score line. The smaller the probe tip, or the better the probe tip and score line alignment, the closer the impact contact point to the crack, and in turn the greater the bending stress in the vicinity of the crack and hence the stress concentration at the crack tip/front. The data of FIG. 9 was taken using a probe location 6 inches inboard, a probe speed of 10 mm/s, an ultrasonic vibrational setting of 20%, a down force of 9.5 pounds or a sheet thickness of less than about 2 mm and width of at least 1 mm, and a contact force of 255 g. The data illustrates that if alignment is good, such as within about 0.5 mm, then separation time is optimized (i.e. about 0.5 seconds in the data illustrated). Misalignment of up to 1 mm may be acceptable, but separation time will occur (e.g., 2 or 3 times, or about 1.0 to 2.0 seconds in the data illustrated).

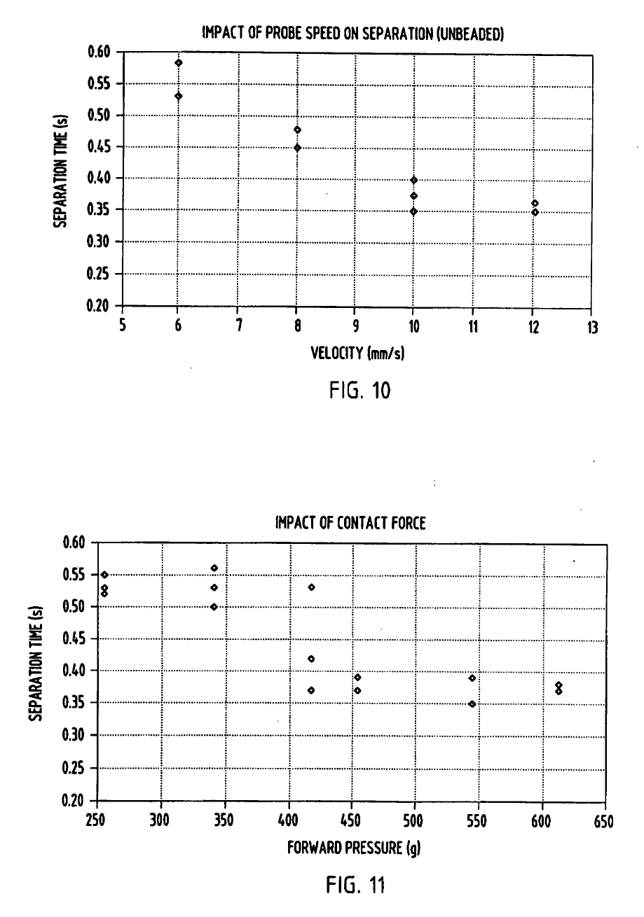

The velocity of the probe affects separation time, as shown by FIG. 10. Specifically, the velocity of the impact subject hitting the glass sheet surface directly affects the impact factor as discussed above. Higher impact velocities reduce separation time. For example, a probe tip velocity of about 6 mm/s at initial impact resulted in a separation time of about 0.53 to 0.58 seconds, while a probe tip velocity of about 10 mm/s resulted in a faster separation time of about 0.35 to 0.4 seconds. The impact force at contact also affects separation time, as shown by FIG. 11. Specifically, higher contact force reduces separation time. However, the amount of contact force allowed is determined by sheet lateral stiffness, and our limit on sheet lateral displacement (which is affected by bowing of the sheet).

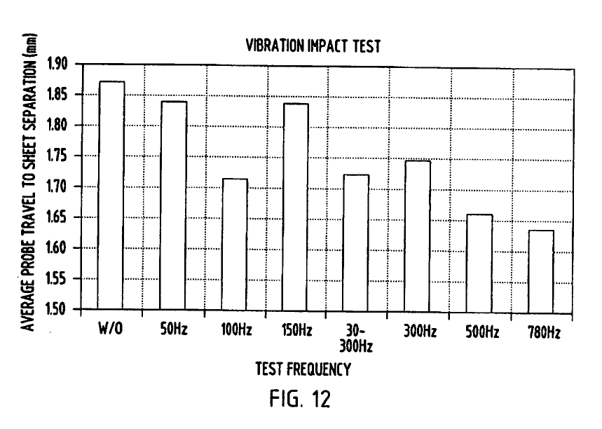

As the frequency of the probe tip is reduced to lower and lower frequencies, the probe travel to cause sheet separation (i.e., crack propagation) increases. The data illustrated in FIG. 12 shows that probe tip frequencies of about 780 Hz can cause separation at probe travel amplitudes of about 1.63 mm, while probe tip frequencies of about 50 Hz may require probe travel amplitudes of about 1.83 mm. This data will of course vary considerably based on specific material properties and process parameters. The probe tip frequency of 500 Hz resulted in an excellent separation time of about 0.35 to 0.37 seconds, with the data for separation between two different tests being relatively consistent, which is a preferred state. To the extent that this phenomena is predictable for a given material or sheet (e.g., its relation to a known property such as natural frequency), it is contemplated that the frequency can be selectively tuned to improve separation times in a given glass-separating process.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A method of separating a sheet of brittle material, the method comprising steps of:
providing a probe with a tip; and
engaging the tip with the sheet and applying sufficient vibrational energy through the probe into the sheet along a score line to induce a crack and propagate the crack along the score line.

2. The method of claim 1, wherein the step of applying sufficient vibrational energy through the probe includes providing a motivator for vibrating the probe, the motivator being selected from a group consisting of: ultrasonic device, a piezoelectric vibration device, an electric motor driven device, and a pneumatically operated device.

3. The method of claim 1, wherein the step of engaging includes engaging the tip with an unscored surface of the sheet.

4. The method defined in claim 3, further comprising separating the sheet by the crack propagating fully along the score line within less than two seconds of engaging the tip with the sheet.

5. The method defined in claim 4, wherein the step of separating the sheet occurs in less than one second after engaging the tip with the sheet.

6. The method of claim 1, further comprising a step of applying a tension of at least about 0.2 lb/in. to the sheet transverse to a length of the score line.

7. The method of claim 1, further comprising a step of applying a tension force to the sheet in a plane of the sheet of at least about 10 pounds force.

8. The method of claim 1, wherein the glass sheet has a width of at least 1000 mm, and including a step of separating the sheet in less than 0.5 seconds.

9. The method of claim 8, applying a tension force to the sheet in a plane of the sheet of at least about 25 pounds force.

10. The method defined in claim 1, wherein the step of applying vibrational energy includes vibrating the tip at least as high as 50 Hz.

11. The method defined in claim 10, wherein the step of applying vibrational energy includes vibrating the tip at least as high as 500 Hz.

12. The method of claim 1, further comprising forming the sheet as a moving ribbon simultaneous with the step of engaging the tip, and wherein the step of engaging the tip includes moving the tip along with the sheet as well as moving the tip across the sheet.

13. The method of claim 1, wherein the step of engaging the tip includes engaging the sheet on an unscored surface within 1.0 mm of alignment with the score line.

14. The method of claim 1, including steps of providing a motivating device attached to the probe, and providing a controller operably connected to the motivating device for controlling the probe, and wherein the step of engaging the tip includes operating the controller to control the vibrational energy from the probe into the sheet.

15. The method of claim 1, wherein the sheet is bowed, and wherein the step of engaging the tip includes contacting the tip with the bowed sheet.

16. A method of separating a sheet of brittle material, the method comprising:
forming a score line in the sheet;
applying a tension to the sheet transverse to a length of the score line; and
applying vibrational energy to the sheet to initiate and propagate a crack along the score line.

17. The method defined in claim 16, including providing a controller for controlling the step of applying vibrational energy, and using the controller to closely control the vibrational energy applied to the sheet.

18. The method defined in claim 17, including providing a probe motivated by a variable vibration motivating device operably controlled by the controller, and operating the probe at a selected optimum frequency of vibration for the sheet material based on a desired maximum time for creating separation in the sheet.

19. The method defined in claim 18, wherein the motivating device is selected from one of an ultrasonic device, a piezoelectric vibration device, an electric motor driven device, and a pneumatically operated device, and operating the probe.

20. The method defined in claim 19, wherein the motivating device is the piezoelectric vibration device.

21. An apparatus for separating a sheet material, comprising:
a scribing assembly for forming a score line in the sheet material;
a vibrational applicator having a probe movably supported and positioned to engage the sheet to induce vibration energy into the sheet for crack initiation and propagation along the score line;
a controller connected to the scribing assembly and the vibrational applicator, the controller selected to engage the probe with the sheet to couple the vibrational energy to the sheet after formation of the score line.

22. The apparatus defined in claim 21, including a tensioner for applying a tensioning force in a plane of the glass in a direction generally perpendicular to the score line.

23. The apparatus defined in claim 21, wherein the vibrational applicator includes a vibrational motivator selected from a group consisting of: ultrasonic device, a piezoelectric vibration device, an electric motor driven device, and a pneumatically operated device.

24. The apparatus defined in claim 21, wherein the probe is movably supported to engage and separate a bowed sheet having a non-planar surface.
